(19) United States
(12) Patent Application Publication
(10) Pub. No.: US 2006/0102860 A1
(43) Pub. Date: May 18, 2006

(54) Liquid dispenser with stem sealing system

(76) Inventors: Timothy M. Garrison, Cinncinnati, OH (US); Gregory A. Balnoschan, Powell, OH (US)

Correspondence Address: DINSMORE & SHOHL, LLP, 1900 CHEMED CENTER, 255 EAST FIFTH STREET, CINCINNATI, OH, 45202, US

(21) Appl. No.: 10/991,762

(22) Filed: Nov. 18, 2004

(51) Int. Cl. F16K 31/44

(52) U.S. Cl. 251/83

(57) ABSTRACT

A sliding stem seal assembly includes a stem having an outer surface and a seal slidably received on the stem. In one embodiment, the seal includes a flared end with inner and outer flanges. In some embodiments, the seal comprises low friction material, such as a TEFLON material for example. In one embodiment, the flared end is also provided with a recess and a cantilever spring, or finger members, tending to bias the inner and outer flanges to provide positive radial pressure for optimizing fluid sealing in low-pressure and zero-pressure modes while minimizing frictional forces in use.

### RELATED APPLICATION

This application is related to U.S. patent application Ser. No. ______ (Attorney Docket No. 3356-185) filed on Nov. 18, 2004 and entitled Liquid Dispenser with Sealing Module, the entire disclosure of which is hereby incorporated herein by reference.

### TECHNICAL FIELD

This invention relates generally to liquid dispensing devices, and more particularly to improved seal assemblies for liquid dispensing devices.

### BACKGROUND OF THE INVENTION

Fluid dispensing assemblies can include a stem for assisting in actuating a poppet valve between opened and closed positions to control fluid flow between an inlet and outlet port. For instance, a fluid dispensing assembly is described in U.S. Pat. No. 3,811,486 (the '486 Patent) to Wood, the entire disclosure of which is hereby incorporated herein by reference.

A fluid dispensing assembly, or nozzle, typically comprises a main body with an inlet port adapted to communicate with a source of pressurized fluid, and an outlet port adapted to dispense fluid from the main body. A stem for actuating a valve is provided and includes an outer surface that slides relative to a packing (typically loose material stuffed or packed in a chamber around the stem). The stem, together with a lever, can assist in actuating the valve, such as a poppet valve, to control fluid dispensing. A guide is adapted to prevent contact between the stem and the main body, while the packing is provided to prevent fluid leakage from the nozzle along the stem and between the stem and main body. In such arrangements, a gland is typically disposed above the packing and has a spring acting thereon. A threaded retainer acts against the spring to maintain the packing in position and acts to pre-load the spring and packing. Pre-loading the packing is undertaken to help maintain a seal when the fluid dispensing assembly is in a low-pressure or zero-pressure mode.

Accordingly, it has been conventional to provide a packing, such as a ½ inch long member that is impregnated with graphite or Teflon material, to prevent leakage of fluid along the stem, and more particularly between the stem and portions of the main body. While advantageous for certain applications, however, such pre-loaded packings may cause an undesirably high friction force and thereby may cause higher required activation forces, and/or undue wear of the seal against the main body and/or stem.

Other sealing arrangements have also been developed and utilized as stem seals, such as those which include a ring-like base or shell (e.g., made of Buna nitrile) having a flared end, as well as an interior energizing member (e.g., an O-ring) disposed within the base to provide outward force on the flared end. However, such seals and sealing systems can exhibit problems with respect to sealing performance and/or durability, and particularly with respect to the unique characteristics encountered when attempting to seal axially sliding stems in fueling devices. For example, such seals may exhibit rapid deterioration and wear from friction and/or from contact with fuels and may also exhibit undesirable changes in size when in contact with such fuels.

### SUMMARY OF THE INVENTION

Accordingly, it is desired to obviate problems and shortcomings of existing seal stem assemblies. More particularly, it is desired to provide improvements in durability and/or performance of sliding seal stem assemblies in fluid dispensing apparatus.

According to one embodiment, a sliding stem seal assembly is provided comprising a stem including an outer surface, and a fluorocarbon-polymer seal slidably received on the stem and comprising inner and outer sealing surfaces. The seal includes at least one recess between the inner and outer sealing surfaces. The inner sealing surface of the seal is adapted to contact the outer surface of the stem to provide a ring-like seal in use. The assembly further includes at least one cantilever spring at least partially disposed in the recess.

According to another embodiment, a fluid dispensing assembly is provided comprising a main body, a stem, a seal slidably received on the stem, and at least one spring. The main body includes an inlet port adapted to communicate with a source of pressurized fluid and an outlet port adapted to dispense fluid from the main body. The stem includes an outer surface, and the stem is adapted to assist in regulating fluid between the inlet port and the outlet port of the main body. A seal is slidably received on the stem and comprises inner and outer walls each having an inner surface. The seal includes at least one recess between the inner and outer walls and defined by the inner surfaces of the walls. At least one spring, comprising a plurality of fingers, is at least partially disposed in the recess.

In accordance with another embodiment, a fluid dispenser is provided comprising a main body, a stem, a polytetrafluoroethylene seal slidably received on the stem, a manual actuator adapted to control movement of the stem, and a shut off actuator adapted to shut off the flow of fluid. The main body includes an inlet port adapted to communicate with a source of pressurized fluid and an outlet port adapted to dispense fluid from the main body. The stem includes an outer surface, and the stem is adapted to assist in regulating fluid between the inlet port and the outlet port. The seal comprises inner and outer sealing surfaces, the inner surface contacting the outer surface of the stem to provide a first seal and the outer surface contacting a portion of the main body to provide a second seal. The manual actuator is adapted to control movement of the stem and control the flow of fluid through the main body, and the shut off actuator is adapted to shut off the flow of fluid upon sensing a fill condition.

In accordance with another embodiment, the fluid dispenser comprises a main body including an inlet port adapted to communicate with a source of pressurized fluid and an outlet port adapted to dispense fluid from the main body. The dispenser further comprises a stem including an outer surface. The stem is adapted to assist in regulating fluid between the inlet port and the outlet port. The dispenser further comprises a seal comprising a friction-reducing material slidably received on the stem and comprising an inner sealing surface. The inner surface contacts the outer surface of the stem to provide a first seal. The dispenser further comprises a manual actuator adapted to control movement of the stem and control the flow of fluid through the main body.

Still other aspects of the present invention will become apparent to those skilled in the art from the following description wherein there are shown and described alternative illustrative embodiments including inventive aspects. These embodiments and descriptions are provided only as illustrative examples, and in no way are intended, nor should they be interpreted, as limiting. As will be realized, the invention is capable of other different embodiments, all without departing from the scope of the invention. These other possible embodiments will be understood by those skilled in the art based upon the description and teachings herein. Accordingly, the drawings and descriptions should be regarded as illustrative and exemplary in nature only, and not as restrictive.

### BRIEF DESCRIPTION OF THE DRAWINGS

While the specification concludes with claims particularly pointing out and distinctly claiming the present invention, it is believed the same will be better understood from the following description taken in conjunction with the accompanying drawings in which:

FIG. 1 is a partial sectional view of an illustrative embodiment of a fluid dispensing assembly made and operating in accordance with principles of the present invention;

FIG. 2 is an enlarged view of a section taken from FIG. 1, showing the sliding stem seal assembly of this embodiment in more detail;

FIG. 3a is a cross sectional view of an illustrative embodiment of an improved sealing system used in the stem seal assembly of FIGS. 1 and 2, and made and operating in accordance with principles of the present invention;

FIG. 3b is a top view of the sealing system of FIG. 3a;

FIG. 4a is a perspective view of an illustrative embodiment of the cantilever spring of the sealing system of FIGS. 3a and 3b;

FIG. 4b is a perspective view of the sealing system of FIGS. 3a and 3b;

FIG. 5 is a cross sectional view of an illustrative embodiment of a fueling nozzle having an improved sealing assembly, made and operating according to principles of the present invention;

FIGS. 6a and 6b are an enlarged sectional views of embodiments of sealing systems having an additional double sealing arrangement, and which are made in accordance with principles of the present invention; and

FIGS. 7a and 7b are enlarged sectional views of embodiments of sealing system having a wiper member, and which are made in accordance with principles of the present invention;

### DETAILED DESCRIPTION OF ILLUSTRATIVE EMBODIMENTS

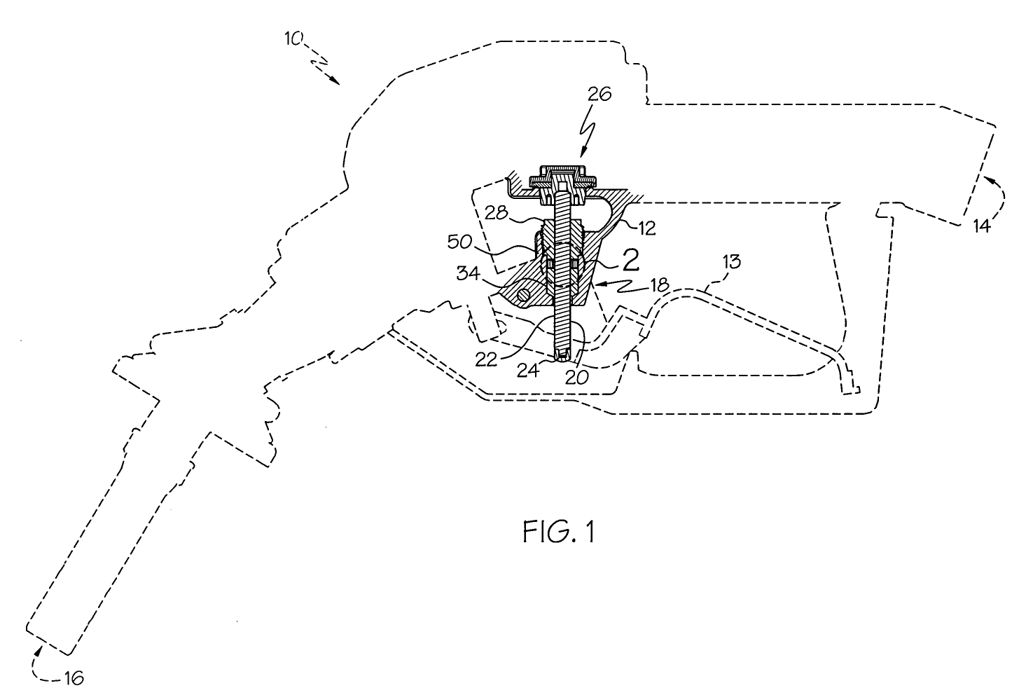

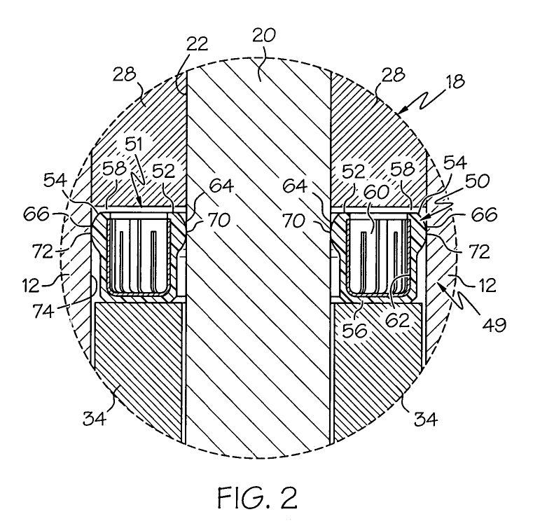

Turning now to the drawing figures in detail, wherein like numbers indicate like elements among corresponding views, FIG. 1 depicts a fluid dispensing assembly 10, made and operating in accordance with principles of the present invention. FIG. 2 illustrates an enlarged sectional view taken from FIG. 1 (as indicated at 2). In this embodiment, the fluid dispensing assembly 10 includes a main body 12 with an inlet port 14 adapted to communicate with a source of pressurized fluid. For instance, in fuel dispensing applications, a high pressure fuel hose can be removably connected to the inlet port 14 to allow a fuel pump (not shown) such as in a gasoline station to act as a source of pressurized fuel for the fuel nozzle 10. The fluid dispensing assembly 10 further includes an outlet port 16 adapted to dispense fluid from the main body 12. In fuel dispensing applications, the outlet port 16 can take the form of a familiar spout or other device adapted to communicate with the inlet opening of a vehicle fuel tank.

As further illustrated in FIG. 1, the fluid dispensing assembly 10 may include a sliding stem seal assembly 18, wherein a stem 20 may axially reciprocate relative to a seal 50 as discussed more fully below. The stem 20 is adapted to assist in regulating fluid between the inlet port 14 and the outlet port 16. For example, as illustrated in FIG. 1, the stem 20 can assist in actuating a valve, such as a poppet valve 26. In order to dispense fluid, an operator will move the actuator, such as lever 13, and the stem 20 therewith, upwardly relative to the main body 12 to open the valve 26. To reduce wear and friction between the stem 20 and the handle 13, the stem 20 may be provided with an optional wear resistant tip 24 made from a material with a relatively low coefficient of friction.

The sliding stem seal assembly 18 can also provide the improved seal 50 at a location between a guide or spacer 34 and a retainer, such as a threaded retainer 28. It is understood, however, that the sliding stem seal assembly 18 could be designed without a spacer 34 and/or retainer 28. For instance, the main body 12 can be designed to independently support and/or retain the seal 50. For example, the main body could be designed with retaining flanges defining a housing for the seal 50.

As an alternative, the seal 50 could reside in a module, which threads into the housing 12. The stem 20 can then be placed through the module, with the seal 50 sealing against the stem and the module, and a separate external seal can seal between the module and main body. The module could comprise a low friction material to reduce wear on the seal 50 caused by movement of the stem, and the module can isolate the external O-ring seal from movement of the stem. The module can comprise multiple rested components if desired.

Returning to FIGS. 1-2, a spacer 34 can be particularly useful to retrofit certain embodiments of the present invention into existing fluid dispensers. For instance, a fluid dispenser could be retrofitted, wherein spacer 34 could operate as an adapter to allow use of the seal 50 in the pre-existing cavity of the main body of an otherwise conventional fluid dispensing assembly. The threaded retainer 28 could also be adapted to be used with a pre-existing fluid dispensing assembly.

An example of retrofitting a convention fluid dispensing assembly with a sliding stem seal assembly embodying aspects of the present invention will now be described. After accessing the stem assembly, the retainer is unscrewed from the main body of the dispenser. The stem assembly including the stem, retainer, spring, gland, packing, and guide are then removed from the main body. Next, a new spacer 34 is mounted onto a stem 20 as will be appreciated from FIGS. 1 and 2. The seal 50 is then slided onto the stem with flared end 51 extending upwardly. The retainer 28 is then slided onto the stem such that the seal 50 is located between the spacer 34 and the retainer. The stem assembly 18 is then inserted into the main body 12, with the retainer 28 being screwed into the main body to trap the seal 50 without pre-loading the seal. In this way, an existing fluid dispensing assembly can be retrofitted such that it includes a sliding stem seal assembly 18 having one or more aspects of the present inventions. As mentioned below, the outer surface 22 of the stem 20 can be improved (e.g., by refinishing the original stem 20 or providing a new stem with an improved surface finish) to improved functionality and prolong operating life in the retrofitted assembly. Construction of a new assembly would be essentially the same as the procedure discussed above, except that old components need not be removed, and a new housing and main body 12 would be provided, along with the other components to build the remainder of the fluid dispensing assembly 10.

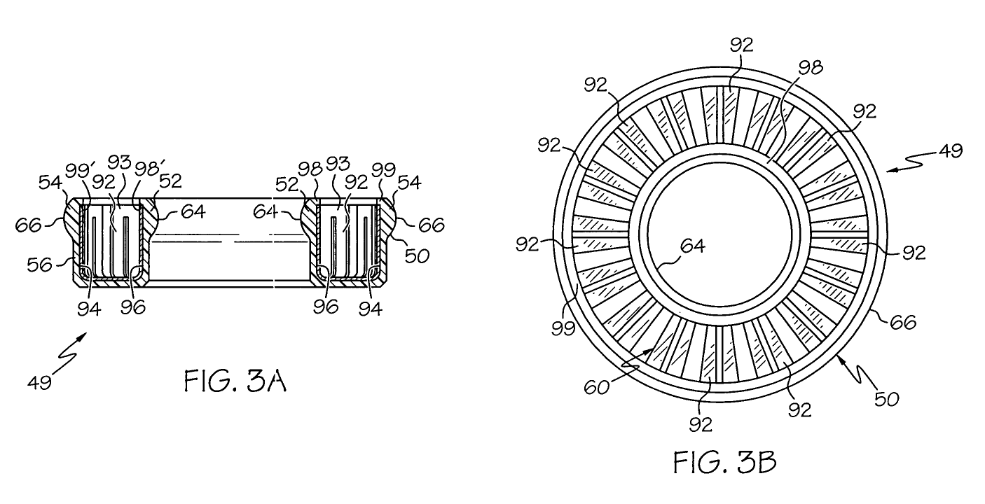

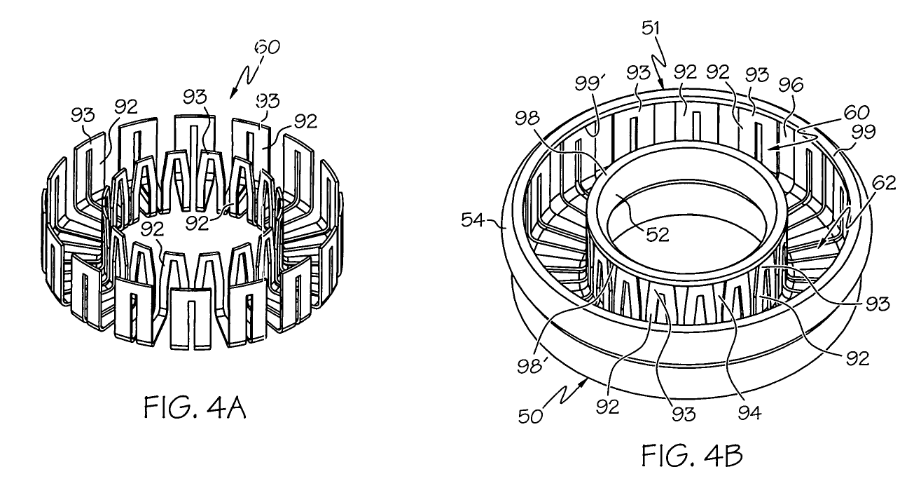

As seen in FIG. 2, and in FIGS. 3a, 3b, and 4, the sealing system 49 of this embodiment includes a seal 50 which includes a base 56 and a flared end 51 with an inner flange 52 and an outer flange 54. As best seen in the enlargement of FIG. 2, inner flange 52 flares radially toward the stem 20 (i.e., in a generally inward direction) while the outer flange 54 flares radially away from the stem 20 (i.e., in a generally outward direction). In one embodiment, the seal 50 is arranged such that the inner flange 52 contacts the outer surface 22 of the stem 20 to create a seal therewith along a circumferential contact surface, edge or lip 64. Since the stem 20 is circular in cross section in this embodiment, the inner flange 52 provides a first or inner ring-like seal at the contact surface, edge or lip 64. In use, the inner flange 52 is deflected slightly inward such that a relatively small portion 70 of the inner flange 52 is in at least partially compressed contact with the outer stem surface 22. Providing a smaller area of contact lowers the friction force between the stem and seal in use, thereby improving the functionality (e.g., ease of actuation and sliding, with superior sealing) of the fluid dispensing assembly while preventing undue wear of either the seal or the stem.

The seal 50 can also be arranged such that the outer flange 54 contacts an inner surface 74 of the main body 12 (or, alternatively, of a surface of the retainer 28 if the seal were housed within the retainer) to similarly create a seal therewith along a circumferential contact surface, edge or lip 66. Since the seal 50 is circular in cross section in this embodiment, the outer flange 54 provides a second or outer ring-like seal adjacent the contact surface, edge or lip 66. As illustrated in FIG. 2, outer flange 54 can deflect slightly inwardly such that a relatively small portion 72 of the outer flange 54 is in at least partially compressed contact with an inner surface 74 of the main body 12 in use. In certain embodiments of the present invention, and as illustrated in FIG. 3b, the first ring-like seal can be at least substantially concentric with the second ring-like seal, via surfaces 64 and 66.

As best shown in FIG. 2, the ring-like contact can be a knife-like contact (e.g., near surface, edge or lip 64, 66) or a limited vertical contact surface (e.g., near contact surface portion 70, 72) to provide a superior seal with reduced frictional forces and excellent wear resistance. The seal provides reliable static and dynamic sealing regardless of fluid pressure. The seal 50 is provided in the shape of a torus or general donut shape having an opening in the center (i.e., either in the center or off-center depending upon the application) to receive and sealingly engage the stem 20 in use.

With reference to FIGS. 1-4, and according to at least some embodiments of the invention, the entire seal 50, or at least the outer surface of the flared end 51 may be made of, or coated with, a material that reduces the coefficient of friction, improves durability when contacting fuel, and/or improves abrasion resistance of the seal. For instance, the seal 50 may consist of entirely or essentially, or partially comprise, a friction reducing material, such as a fluorocarbon polymer for example. In particular, polytetrafluoroethylene, fluorinated ethylene-propylene, ethylene tetrafluoroethylene, or perfluoroalkoxy may be utilized, such as those types of materials marketed under the trademark TEFLON® (as available from E.I. DuPont de Nemours). In addition, with respect to other embodiments having other inventive aspects, high performance friction reducing elastomers could be utilized, such as POLYMOD® (as available from Polymod Technologies, Inc.), or other friction reducing materials compatible with the seal 50 and the application requirements. For example, elastomeric polymers (e.g., nitrile) or elastomers which are polymer modified to have very low coefficients of friction and optimized wear life could also be utilized in some embodiments.

However, it has been found that particularly advantageous performance and durability (with respect to friction characteristics, and durability and size stability when in contact with fuel) can be attained by constructing substantially the entire seal 50 using a TEFLON material. In addition, the inner surface 74 of the main body 12 and/or the outer surface 22 of the stem 20 may be appropriately finished and/or coated or treated to further prevent undue friction and wear, and to optimize the service life of the assembly. In one example of a fuel dispenser nozzle stem, the outer surface 22 of the stem 20 may be optionally finished with a finish of at least 12 for use with a seal 50 having a TEFLON coating, or comprising or consisting of TEFLON. The material used to construct the seal 50, partially or completely, preferably results in a dynamic and/or static coefficient of friction relative to the stem of less than about 0.1, such as less than about 0.05 for example, which can result in improved performance of the fueling nozzle. In particular, according to one embodiment of the invention, using a seal made from TEFLON and a stem made of stainless steel can provide a coefficient of friction of the seal relative to the stem of about 0.04.

As shown in FIGS. 1-4, the seal 50 of at least some embodiments can also be energized such that the flared end 51 will include an appropriate positive or active outward radial bias to provide sufficient pressure, and therefore provide a sufficient fluid seal to minimize any potential for leakage along the stem 20 and between the stem and its adjacent main body 12, when the nozzle is in either a low-pressure mode or a zero-pressure mode. As used herein, the term “energized” refers to any material, structure, or combination of material and structures which tends to bias the inner and outer flanges outwardly from the seal body so that, in use, sealing contact can be positively or actively maintained even where there are no fluid pressure forces compressing the seal. In one example the flared end 51 of the seal 50 includes a recess 62 between the inner and outer flanges. Optionally providing the flared end 51 with a recess 62 permits the flared end to expand under the influence of fluid pressure to allow the outer surfaces of the flanges to also more efficiently seal as fluid pressure increases.

Energizing the seal 50 can be achieved in a variety of ways. In one example, the flared end 51 of this embodiment may be energized by the choice of materials or other geometrical characteristics of the flared end. In another example, the flared end may be a composite of different materials having different properties, the materials energizing the flared end. In still further embodiments of the present invention, the energizing of the flared end is achieved with an energizing member 60. As illustrated, the energizing member 60 can be at least partially located within the recess 62 of the seal 50. It is understood that the energizing member 60 may alternatively be substantially or entirely located within the recess. Furthermore, the energizing member 60 may be encapsulated within the flared end of the seal. For example, the energizing member may be fabricated from a different material and then embedded and concealed within the flared end. Due to differing material properties, the energizing member 60 could then act to energize the flared end 51 of the seal. In other examples, a wedge could be used as the energizing member to cause the flanges to bias away from one another. In still other examples, the energizing member could take the form of a pressurized bladder, an O-ring, or material compressed within the flared end of the seal, or any material or component suitable to cause the flanges 52 and 54 to bias away from one another. With respect to other aspects of the inventions, it will be understood that other shapes of energizing members could be used, such as energizing members with square, rectangular, triangular, wedge-shaped, or other cross sectional shapes, or that the energizing member could be removed. Moreover, while a single energizing member is illustrated in the embodiments, it is understood that a plurality of energizing members could be provided, and that the energizing member need not be unitary in nature. For example, a plurality of spaced, or overlapping energizing members might be placed within a recess. For instance, a plurality of O-rings could be stacked, one upon another, or concentrically arranged. In addition, a plurality of energizing members, such as spheres or ball bearings could be radially arranged at least partially within the recess of the seal. Similarly, it will be understood that the seal could be formed with a plurality of recesses that can each receive one or more energizing members. With respect to some embodiments incorporating aspects of the inventions, the energizing member could take other forms, such as a hollow ring. In still other embodiments, the energizing member may take the form of a coil spring, or similar arrangement, connected end-to-end in the shape of a torus.

Returning to FIGS. 1-4, and in particular as best shown in FIGS. 4a and 4b, in some embodiments it has been found particularly advantageous to use an energizing member 60 that takes the form of a cantilevered spring. In particular, the figures depict the energizing member 60 in the form of a cantilever spring, comprising a plurality of fingers which serve to provide a force against the seal 50, to improve sealing performance. FIGS. 3a, 3b, and 4b illustrate the seal 50 and cantilever spring 60 of this embodiment in more detail. FIG. 4a illustrates the cantilever spring 60, without the seal 50 which retains the spring. As shown in these figures, the spring 60 is disposed in the recess 62 of the seal 50, and comprises a cantilever spring having a plurality of fingers 92. Each of the fingers 92 runs between an inner wall 94 of the seal 50 and an outer wall 96 of the seal, the inner and outer walls defining the recess of the open, hollow, donut-shaped seal 50. Accordingly, the fingers 92 are each bent or otherwise disposed in a general U-shape within the recess 62. To hold the fingers 92 within the seal 50, the seal can be provided with an inner top lip 98 and an outer top lip 99, such that the two ends 93 of each finger 92 can be held under the respective inner surfaces 98′ and 99′ of these lips, and thereby retained from exiting the open end 51 of the seal 50. Alternatively, other structures can be provided to hold the spring 60 within the seal 50.

In addition, in this embodiment, the fingers 92 are connected at their ends 93, such as by an integral connection, which allows the spring 60 to form a single continuous unit from its two end points. By positioning and retaining the spring 60 in the recess 62 in this manner, the fingers 92 of the spring provide a substantially uniform or constant force or load on the inner and outer walls 94 and 96 of the seal 50. It has been found that this arrangement can provide improved sealing performance of the lip 64 against the stem 20 and of the lip 66 against the main body 12, even under varying loads, pressures, and conditions.

As an alternative to the cantilever spring 60, other finger-type springs, flexible fingers, or flexible linear members might be utilized. Such members can be disposed, bent, or compressed between the inner and outer walls 94 and 96 to provide force on these walls to improve the performance of the seal 50.

As best illustrated in FIG. 2, the seal 50 may be arranged such that it is trapped between the retainer 28 and the spacer 34. In addition, the seal 50 may be arranged such that the distance between the retainer 28 and the spacer 34 is greater than the height of the seal 50, thereby forming an intermediate space 58. The intermediate space 58 allows for expansion of the seal and can prevent unnecessary pre-loading of the seal by the retainer 28. Such pre-loading is not required and not necessarily desirable, as it may tend to unduly increase frictional forces and operating forces, as discussed with previously available seal arrangements. This space also allows for fluid pressure to act on the seal to enhance the resulting seal during high pressure dispensing operations. In addition, as discussed previously, the retainer 28 can have an extension portion that engages spacer 34 so that the seal 50 resides between the stem 20 and stainless steel retainer 28, and is isolated from the higher friction surface of the main body 12.

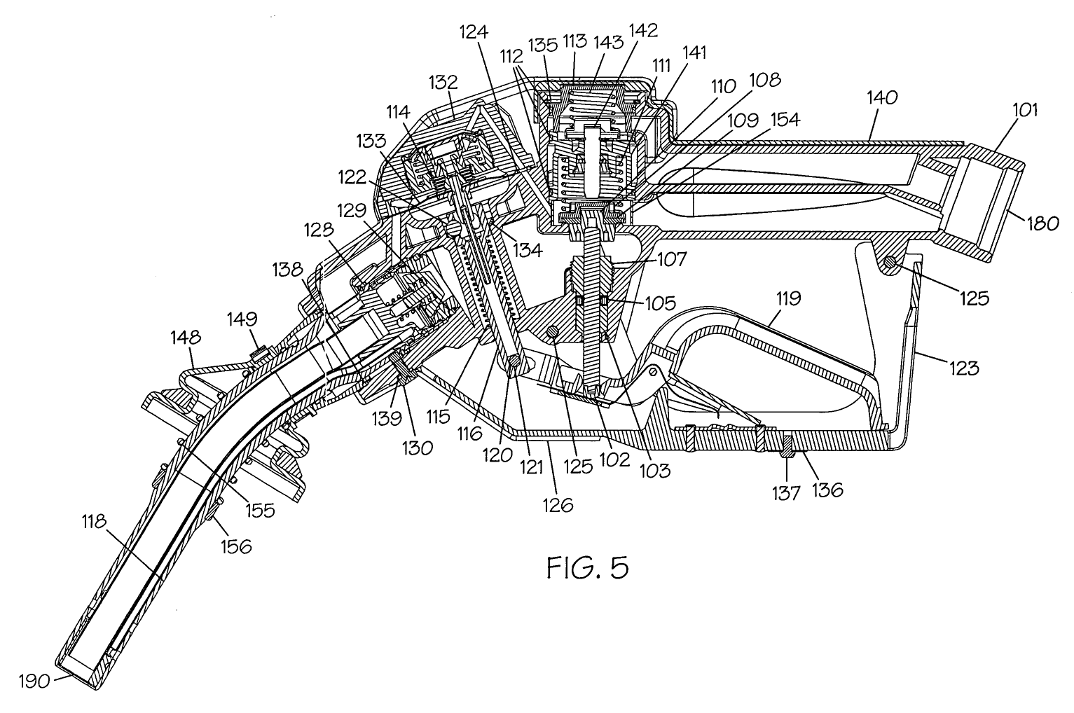

FIG. 5 is a cross sectional view of a fuel dispensing assembly with the improved sliding stem seal assembly and sealing system of FIGS. 2-4, made and operating according to principles of the present invention. This embodiment illustrates other components that can be included in a fuel dispensing assembly, as desired or appropriate. In this example, the assembly includes a main body 101, such as can be made of cast aluminum, and a stem assembly 102, which can include a stainless steel stem and a wear resistant tip. In addition, a spacer 103 can be provided, along with a sealing system 105, such as similar to those embodiments 49 described above. For example, the sealing system 105 can include a TEFLON seal and an internal cantilever spring. A threaded retainer 107 can also be provided to hold these components with the main body 101. A manual lever or actuator assembly 119 can also be provided, which in this example includes a lever, a lower lever, a trigger, a spring to bias the trigger, and a rivet for securing the components. Near the top of the stem is provided a disc holder 108 which retains a disc 109, both of which are provided on a skirt 110. These components serve as an interface between the stem and the main spring 111 which biases the stem. O-rings 112 or similar seals can be provided for sealing of components, as shown. A filter screen 154 can also be provided to filter the pressurized fuel flowing through the nozzle from the inlet end 180 to the outlet end 190. A guard sub-assembly 123 can also be provided to guide and protect the lever 119, and can include a guard piece, a rack, and a rivet.

The operation of the lever assembly 119 with respect to the stem assembly 102 can be similar to that described above with respect to the other embodiments. In particular, movement of the poppet stem 102 by the lever 119 can move the skirt 110 and disc 109 off of their seat, permitting fuel to flow through the housing, and in particular, from the inlet end 180, around the poppet stem 102 and shut off components held within the housing (described below), and out the spout end 190.

Another spring 143 can be provided between a body cap 113 and a vapor valve 141, which can comprise, for example, a valve body, a stem 142, a lip seal, an insert, retaining rings, and a disc and disc holder. The spring 143 can be used for biasing the vapor valve. Another retaining ring 135 can be provided for retention of components. The vapor valve can operate as known in the art for flow of vapors.

In addition, a shut-off valve assembly 132 can be provided for automatic shut off of the fuel flow upon detection of a full condition in a fuel tank. This assembly can include a diaphragm biased by a spring, a support cup, a support, and other components such as a snubber, a wear washer, and a cap. In addition, a diaphragm sub-assembly 133 can be provided, which can include a diaphragm and diaphragm support, a lower diaphragm connector, a flat washer, and an upper pin and spring pin. Additional shut-off components can include a diaphragm spring 114, a latch spring 115, a latch ball 122, a latch ring 134, and a latch plunger 116, and the shut-off components can connect with the lever 119 via a plunger pin 120 and push nut 121. These components can operate in ways known in the art, or later to be developed, for automatic shut off of the nozzle, such as by using Venturi vacuum principles for example.

The spout end of the fueling nozzle can include a spout sub-assembly 118 including a tube, spring, poppet, bleeder seat ring, outer tube, sleeve, and ferrule, as well as various O-rings for sealing, and retaining rings for securing components. A vapor escape guard 148, and clamp 149 therefor, can also be provided to prevent escape of vapors. An anchor spring 155 and ring 156 can also be utilized. The spout components can operate as known in the art or in a desired manner.

Other components can also be provided, as needed or desired, to create the appropriate fueling nozzle for the application at issue. For example, rivets 125 and screws 130 can be provided for securing components together, insulating material 126 and 140 can be provided to insulate the metal pieces from the user, identification washer 136 and screw 137 can be provided for identification of the nozzle, and O-rings 138, 139, 128, 129, and 124 can be provided for appropriate sealing of components.

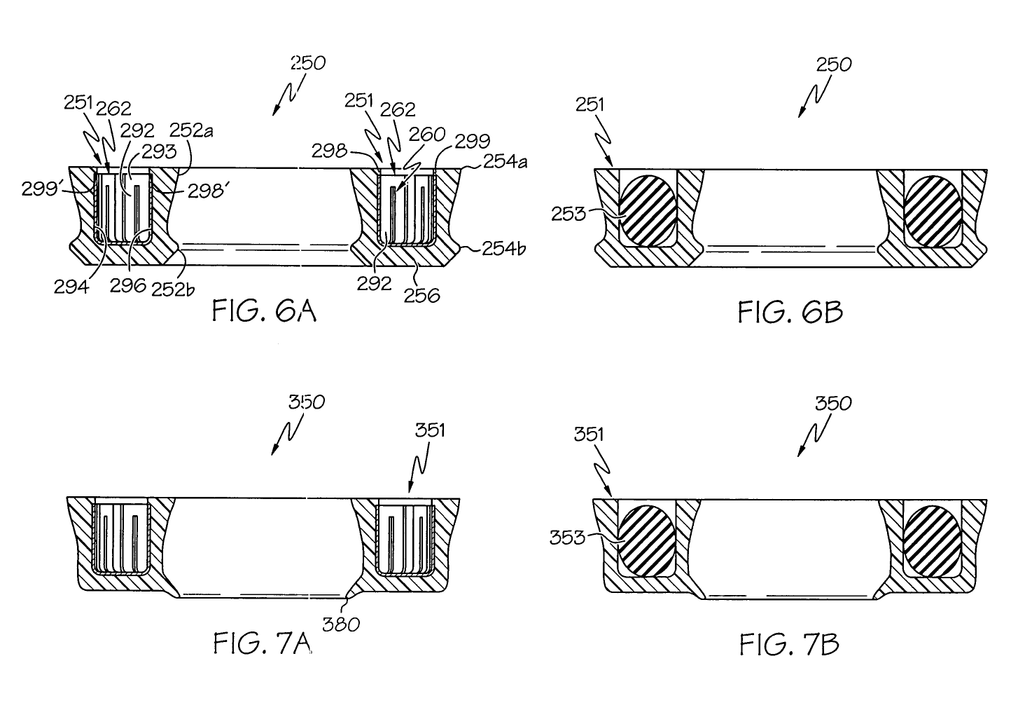

FIG. 6a depicts another embodiment of a seal 250 made in accordance with principles the present invention. The seal 250 includes an energized flared end 251 with a pair of inner flanges, 252a, 252b and a pair of outer flanges 254a, 254b forming a double sealing arrangement. The double sealing arrangement can improve the stability of the seal (i.e., by providing support at two locations rather than one location) while increasing the sealing strength of the seal. It should be noted, however, that only the flared end 251 includes a cantilever spring 260 in recess 262. In this example, the additional flanges 252b and 254b can provide more conventional or less-energized seals in use. It is contemplated that a second recess and energy member (not shown) could be provided adjacent base 256 of seal 251 if it were desirable to equip the seal with a double pair of energized inner and outer seals.

FIG. 7a illustrates yet another embodiment of a seal 350 with an energized flared end 351. At least one circumferential wiper 380 is provided to help prevent debris and other contaminants from traveling through the seal. This arrangement might be desirable where the application is subjected to dust, particles, grit or other contaminants, which could undermine the seal or otherwise foul the dispensing operation or fluid delivery. It will be understood that the features of FIGS. 6 and 7 could alternatively be combined such that a seal includes a double sealing arrangement with at least one additional wiper.

The seal of the present invention may be made in any conventional manner, such as by injection molding or other molding processes. In some embodiments, the material of the seal 50 might also be selected from a material with low swell/shrink characteristics. Low swelling is often desirable since exposure to fluids could result in fluid absorption, and thereafter swelling of the seal. This can change the dimensions and/or performance characteristics of the material. For fuel dispensing applications, it has been found that using a TEFLON seal and a stainless steel stem can provide ideal durability, and minimize shrinking and swelling when in the presence of fuel. For example, in FIGS. 6a and 7a, the seals 250 and 350 can be made of a TEFLON material. In FIGS. 6b and 7b, the seals 250 and 350 are similar that those shown in FIGS. 6a and 6b and are entirely made from a TEFLON material. In these examples, the energizing member comprises an O-ring 253/353.

The foregoing description of the various embodiments of the invention has been presented for the purposes of illustration and description. It is not intended to be exhaustive or to limit the inventions to the precise form disclosed. Many alternatives, modifications and variations will be apparent to those skilled in the art of the above teaching. For example, although multiple inventive aspects have been presented, such aspects need not be utilized in combination, and various combinations of aspects are possible in light of the various embodiments provided above. Accordingly, it is intended to embrace all possible alternatives, modifications, combinations, and variations that have been discussed and suggested herein, and all others that fall within the principles, spirit and broad scope of the inventions as defined by the claims.

What is claimed is:

1. A sliding stem seal assembly comprising:
a valve configured to move between open and closed positions;
a stem including an outer surface and configured to move in a direction along its longitudinal axis to cause movement of the valve;
an actuator configured to cause movement of the stem;
a seal comprising a fluorocarbon polymer, wherein the seal is slidably received on the stem such that the stem is configured to move axially relative to the seal, wherein the seal comprises inner and outer sealing surfaces and at least one recess between the inner and outer sealing surfaces, wherein the inner sealing surface is adapted to contact the outer surface of the stem to provide a ring-like seal in use; and
at least one cantilever spring at least partially disposed in the recess.

2. The sliding stem seal assembly of claim 1, wherein the cantilever spring at least partially abuts the inner and outer sealing surfaces to provide a substantially constant load upon the inner and outer flanges.

3. The sliding stem seal assembly of claim 1, wherein the seal includes at least one edge adapted to hold the spring within the recess.

4. The sliding stem seal assembly of claim 1, wherein the cantilever spring is arranged in the recess in a general U-shape, and comprises a plurality of fingers connected end to end.

5. The sliding stem seal assembly of claim 1, wherein the seal comprises at least one of a polytetrafluoroethylene, fluorinated ethylene-propylene, ethylene tetrafluoroethylene, and perflouoroalkoxy.

6. A fluid dispensing assembly comprising:
a main body including an inlet port adapted to communicate with a source of pressurized fluid and an outlet port adapted to dispense fluid from the main body;
a stem including an outer surface, wherein the stem is adapted to assist in regulating fluid between the inlet port and the outlet port;
a seal slidably received on the stem and comprising inner and outer walls each having an inner surface, the seal including at least one recess between the inner and outer walls and defined by the inner surfaces of the walls; and
at least one spring at least partially disposed in the recess, wherein the spring comprises a plurality of fingers.

7. The fluid dispensing assembly of claim 6, wherein the inner wall is adapted to contact the outer surface of the stem to provide a ring-like seal in use.

8. The fluid dispensing assembly of claim 6, wherein the spring at least partially abuts the inner and outer walls to provide a constant load upon the inner and outer walls.

9. The fluid dispensing assembly of claim 6, wherein the spring is arranged in a general U-shape.

10. The sliding stem seal assembly of claim 6, wherein the seal comprises at least one of TEFLON and an elastomeric polymer.

11. A fluid dispenser comprising:
a main body including an inlet port adapted to communicate with a source of pressurized fluid and an outlet port adapted to dispense fluid from the main body;
a stem including an outer surface, wherein the stem is adapted to assist in regulating fluid between the inlet port and the outlet port;
a polytetrafluoroethylene seal slidably received on the stem and comprising inner and outer sealing surfaces, wherein the inner surface contacts the outer surface of the stem to provide a first seal and wherein the outer surface contacts a portion of 10 the main body to provide a second seal;
a manual actuator adapted to control movement of the stem and control the flow of fluid through the main body; and
a shut off actuator adapted to shut off the flow of fluid upon sensing a fill condition.

12. The fluid dispenser of claim 11, wherein the polytretra fluoro-ethylene seal further comprises a flared end having an inner flange defining the inner surface and an outer flange defining the outer surface.

13. The fluid dispenser of claim 12, wherein the polytretra fluoro-ethylene seal comprises a recess between the inner and outer flanges, and wherein the assembly further comprises a spring disposed in a recess of the polytretra fluoro-ethylene seal, the spring at least partially abutting the inner and outer flanges of the flared end to provide a constant load upon the inner and outer flanges, wherein the spring comprises multiple cantilever fingers connected end-to-end.

14. The fluid dispenser of claim 13, wherein the spring is arranged in a general U-shape.

15. The fluid dispenser of claim 13, wherein the spring is a cantilever spring.

16. The fluid dispenser of claim 13, wherein the polytretra fluoro-ethylene seal has at least two edges adapted to hold the spring within the recess.

17. The fluid dispenser of claim 11, wherein the first seal is at least substantially concentric with the second seal.

18. The fluid dispenser of claim 11, wherein the polytretra fluoro-ethylene seal includes a recess and wherein the assembly comprises a spring disposed within the recess.

19. A fluid dispenser comprising:
a main body including an inlet port adapted to communicate with a source of pressurized fluid and an outlet port adapted to dispense fluid from the main body;
a stem including an outer surface, wherein the stem is adapted to assist in regulating fluid between the inlet port and the outlet port;
a seal comprising a friction-reducing material slidably received on the stem such that the stem is configured to move axially relative to the seal, wherein the seal comprises a flange and an inner sealing surface, wherein the inner surface contacts the outer surface of the stem to provide a first seal;
an energizing member disposed within the seal and configured to provide a radial force on the flange to maintain the inner surface of the seal in contact with the outer surface of the stem; and
a manual actuator adapted to control movement of the stem and control the flow of fluid through the main body;

20. The fluid dispenser of claim 19 wherein the friction-reducing material comprises a fluorocarbon polymer.

21. The fluid dispenser of claim 19 wherein the friction-reducing material comprises at least one of polytetrafluoroethylene, fluorinated ethylene propylene, ethylene tetrafluoroethylene, and perfluoroalkoxy.

22. The fluid dispenser of claim 19, wherein the friction reducing material has a coefficient of friction of less than or equal to 0.1 relative to the stem.

23. The fluid dispenser of claim 19, wherein the friction reducing material has a coefficient of friction of less than or equal to 0.05 relative to the stem, and wherein the stem comprises stainless steel.
